(19) United States
(12) Patent Application Publication
(10) Pub. No.: US 2019/0116759 A1
(43) Pub. Date: Apr. 25, 2019

(54) FETCH TOY WITH INTERNALLY ANCHORED ELASTIC CORD

(71) Applicant: Steven Petitt, Atlantic Beach, FL (US)

(72) Inventor: Steven Petitt, Atlantic Beach, FL (US)

(21) Appl. No.: 16/165,046

(22) Filed: Oct. 19, 2018

Related U.S. Application Data
(60) Provisional application No. 62/574,703, filed on Oct. 19, 2017.

(51) Int. Cl. A01K 15/02; A63B 37/00; A63B 69/00

(52) U.S. Cl. CPC A01K 15/025; A63B 69/0088; A63B 37/00

(57) ABSTRACT

A toy includes a hollow elastomeric object with an elastic tether extending through a narrow aperture in the object from an anchor contained within the object. The free end of the tether includes a handle. About 12 to 24 inches of tether extend from the object. The object is a suitable size and shape for playing fetch with a dog. The anchor is larger (e.g., wider) than the aperture, thus impeding inadvertent removal of the anchor through the aperture.

### RELATED APPLICATION

This application is a nonprovisional and claims the benefit of priority of U.S. Provisional Application 62/574,703 filed Oct. 19, 2017.

### FIELD OF THE INVENTION

This invention relates generally to toys, and, more particularly, to a hollow toy with an anchored elastic cord that facilitates propelling the toy a long distance.

### BACKGROUND

Balls are popular toys, particularly for dogs who enjoy a game of fetch. Many pet owners may have a difficult time throwing a ball a sufficient distance to fully engage their pet and provide the activity necessary for the animal's well being.

Some dog throw toys on the market use a rope and ball that is usually routed completely through the ball. The ropes tend to be thick, inelastic and knotted on the outside of the ball. They are not designed for long distance throwing. Rather they are more suited for chewing and tug of war.

There are numerous launching devices on the market in the dog throw market space. One example is a catapulting arm with a cradle to hold a ball while launching. It requires the thrower to have 2 things—the ball and a cumbersome catapulting arm. Effective use of the catapulting arm requires practice. It is difficult, especially for the uninitiated, to launch the ball at the proper angle and trajectory to maximize and direct the flight of the ball. Another issue with these types of launching devices is that release of the ball requires abrupt deceleration, putting stress on the muscles, tendons, and joints of the elbow and shoulder, potentially leading to overuse injuries.

What is needed is an easy to use ball that is suitable for fetching and easy to propel a long distance. The ball should be easy to store, such as in a pocket or bag.

The invention is directed to overcoming one or more of the problems and solving one or more of the needs as set forth above.

### SUMMARY OF THE INVENTION

To solve one or more of the problems set forth above, in an exemplary implementation of the invention, a ball includes an internal cavity and an aperture extending from the internal cavity to the exterior surface of the ball. An elastic tether (e.g., a shock cord) has a handle at one end and an anchor at the other end. The aperture has a dimension (e.g., width or diameter) that is smaller than the dimension (e.g., width or diameter) of the anchor. The ball is comprised of an elastomeric material (i.e., a rubber or rubber-like material that exhibits elasticity), which allows the anchor to be urged through the aperture for installation of the anchored end of the tether, without tearing or otherwise comprising structural integrity of the ball around the aperture. When installed, the size of the anchor prevents inadvertent dislodgement (i.e., removal) through the smaller aperture. The ball is a suitable size for playing fetch with a dog.

The anchor is preferably a knot. The knot is contained within the internal cavity of the ball. The knot is large enough to resist inadvertent dislodgement (i.e., removal) through the small aperture. A washer having an outer diameter that is larger than the diameter of the small aperture, and an inner diameter that is slightly larger than the diameter of the tether, is disposed between the knot and the small aperture with the tether extending through the central aperture of the washer

The anchor is preferably a substantially rigid material such as a molded plastic or metal. A nonlimiting example of an anchor is one or more metal washer's each having an outer diameter that is greater than the maximum width or diameter of the aperture. The anchor may be secured to the end of the tether with a knot, cinch, clamp or other mechanical fastener. Alternatively, the end of the tether may be bonded to the anchor.

The handle may be a knob, sphere, handgrip or other structure that is attached to the end of the tether opposite the anchor. The handle helps impede a user's hand from sliding off the end of the tether.

The tether is elastic and several inches in length. In a nonlimiting example, the tether may be a shock cord. In a nonlimiting example, the tether may be from 6 inches to 36 inches in length, with lengths of about 12 to 24 inches being preferred, and a length of about 20 inches being particularly preferred.

The invention is not limited to ball-shaped toys. Other shapes, such as bone, animal, stick, or dumbbell shapes that are suitable for fetching may be used without departing from the scope of the invention.

In sum, the invention provides a toy suitable for fetching. In one exemplary embodiment, the toy includes a hollow object that may be ball shaped or shaped as another object suitable for fetching. The hollow object is preferably made of a resilient elastomeric material, e.g., a rubber or rubber-like material. The hollow object has an internal cavity and a first aperture. The first aperture has a first diameter. A tether has a first end and a second end, the second end being opposite the first end. A first portion of the tether extends through the first aperture into the internal cavity of the hollow object. The first end of the tether is in the internal cavity of the hollow object. The second end of the tether is outside of the hollow object. The tether is elastic (e.g., shock cord). An anchor is provided at the first end of the tether. The anchor has a width that is greater than the first diameter of the first aperture. The anchor may comprise a knot, a knot and a washer with the tether extending through the washer, a knot and a washer with the tether extending through the washer and the washer lodged into a notch in the hollow object between the internal cavity of the hollow object and the first aperture. Other examples of anchors include a crimped ferrule or band at the first end of the tether.

A handle may be attached to the second end of the tether. Such a handle facilitates gripping and use.

To facilitate assembly and drainage the hollow object may include a second aperture opposite the first aperture. Such a second aperture has a second aperture diameter that is greater than the width of the anchor, which is greater than the first diameter of the first aperture. Optionally, a plug may be securely inserted into the second aperture.

### BRIEF DESCRIPTION OF THE DRAWINGS

The foregoing and other aspects, objects, features and advantages of the invention will become better understood with reference to the following description, appended claims, and accompanying drawings, where:

FIG. 1 provides a perspective view of an exemplary ball with an internally anchored elastic cord, according to principles of the invention; and

FIG. 2 provides a perspective section view of an exemplary ball with an internally anchored elastic cord, according to principles of the invention; and

FIG. 3 provides another perspective section view of an exemplary ball with another internally anchored elastic cord, according to principles of the invention; and

FIG. 4 provides another perspective section view of an exemplary ball with another internally anchored elastic cord, according to principles of the invention; and

FIG. 5 provides a perspective view of an exemplary ball with a plug according to principles of the invention; and

FIG. 6 provides a perspective exploded view of an exemplary handle for a ball, according to principles of the invention; and

FIG. 7 provides a back view of an exemplary ball with an internally anchored elastic cord, according to principles of the invention; and

FIG. 8 provides a side view of an exemplary ball with an internally anchored elastic cord, according to principles of the invention; and

FIG. 9 provides a top view of an exemplary ball with an internally anchored elastic cord, according to principles of the invention; and

FIG. 10 provides a front view of an exemplary ball with an internally anchored elastic cord, according to principles of the invention; and

FIG. 11 provides a first perspective view of an exemplary ball with an internally anchored elastic cord, according to principles of the invention; and

FIG. 12 provides a second perspective view of an exemplary ball with an internally anchored elastic cord, according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

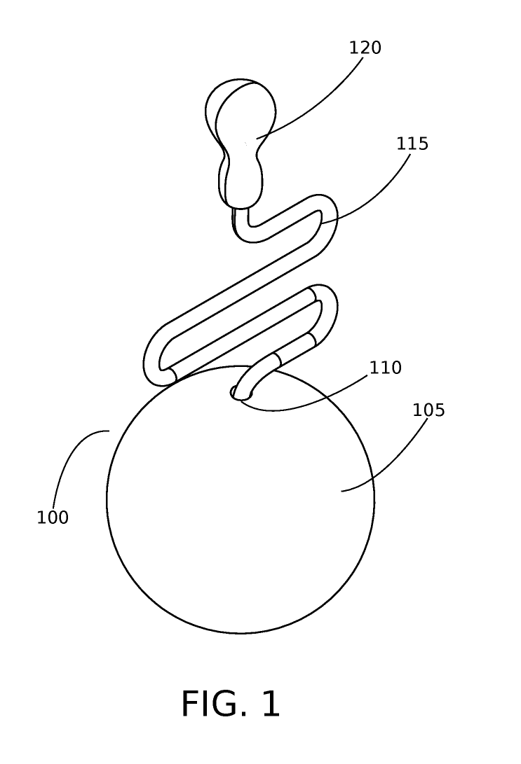

FIG. 1 provides a perspective view of an exemplary toy 100 according to principles of the invention. The toy 100 includes a ball 105 with an internal cavity (i.e., a hollow ball 105), an internally anchored elastic tether 115 extending from an aperture 110 in the ball 105, and a handle 120 attached to the free end of the elastic tether 120. The elastic tether 115 (e.g., a shock cord) has a handle 120 at one end and an anchor at the other end. The aperture 110 has a dimension (e.g., width or diameter) that is smaller than the dimension (e.g., width or diameter) of the anchor.

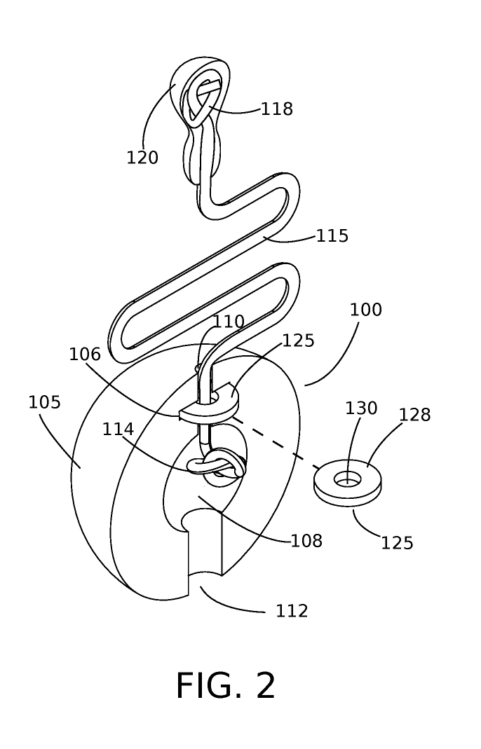

With reference to the section view of FIG. 2, the anchor is a structure contained in the internal cavity 108 of the ball 105. The anchor structure is too large to fit through the aperture 110. In an exemplary embodiment, the anchor is a knot 114. As the diameter of the tether 115 is about equal to (or only slightly less than) the diameter of the aperture 110, the knot 114 cannot, practically speaking, fit through the aperture 110.

Optionally, an annular (i.e., flat ring) washer 125 is disposed between the knot 114 and the aperture 110. The outer diameter defined by the periphery of the annulus 128 of of the washer 125 is greater than the diameter or width of the aperture 110. The inner diameter of the central aperture 130 of the washer 125 is the same as, or slightly larger than the diameter or width of the tether 115. A portion of the tether 115 extends through the central aperture of the washer 125. In the embodiment of FIG. 2, the washer is contained in a notch 106 in the ball 105 between the aperture 110 and the knot 114 in the internal cavity of the ball 105.

The ball 105 is comprised of a resilient elastomer. The ball 105 may be deformed, compressed and stretched to receive the washer 125 in the notch 106 without structural failure, such as tearing.

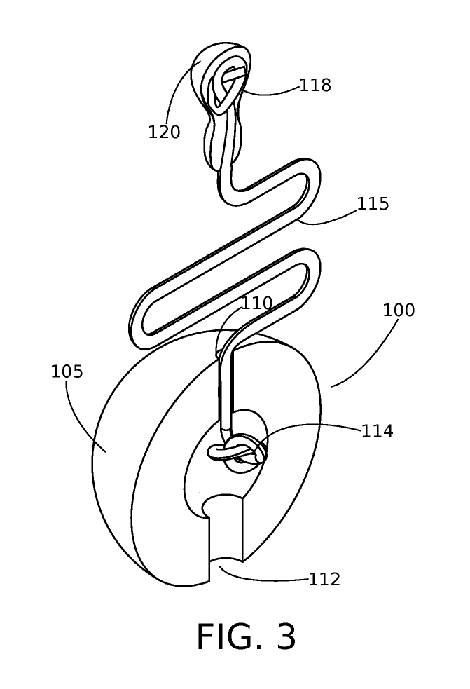

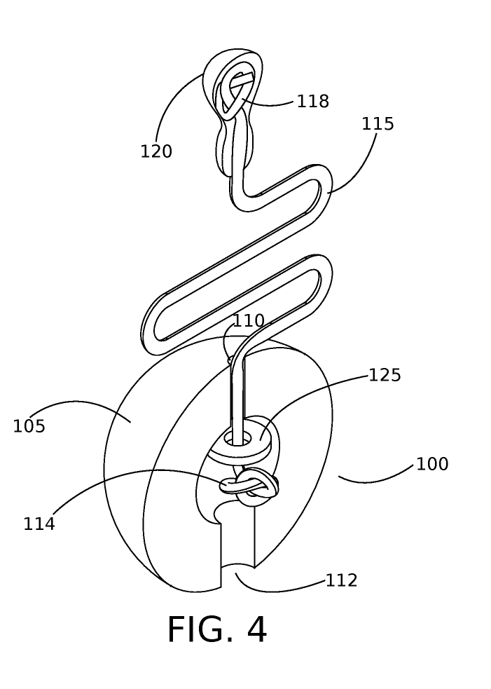

FIGS. 3 and 4 conceptually illustrate alternative anchors. In FIG. 3, the anchor is comprised of a knot 114 without a washer. In FIG. 4, the anchor is comprised of a knot 114 with a washer 125. However, the washer 125 in FIG. 4 is contained in the internal cavity 108 of the ball 105, and not in a separate notch 106 as in FIG. 2.

In another embodiment, the anchor may be a substantially rigid material such as a molded plastic or malleable metal ferrule, band or bushing. A ferrule is a malleable sleeve with an internal diameter about the same as the diameter of the tether 115. The anchor may be crimped or otherwise secured to the end of the tether 115.

The end of the tether 115 contained in the handle 120 may be knotted 118. The handle may be hollow and securely contain the knotted end. Alternatively, the handle 120 may be over-molded onto the end of the tether 115. As an another alternative, the handle 120 may be heat shrunk onto the end of the tether 115.

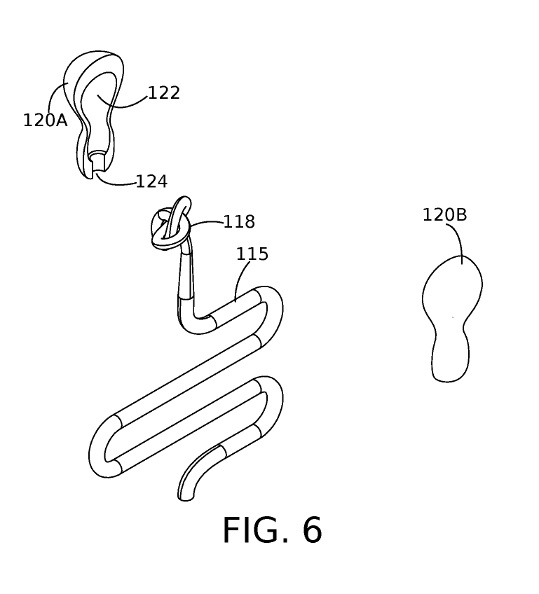

As yet another alternative, the handle may comprise two pieces (e.g., two halves) 120A, 120B (FIG. 6) that define a hollow cavity 122 when assembled. The end of the tether 115, e.g., the knotted end 118, may be contained in the hollow cavity 122. The two halves 120A, 120B may be bonded or fastened together, with the knot 118 contained in the cavity 122. Bonding may be accomplished with a chemical bonding agent or ultrasonic welding. Fastening may be accomplished with mechanical fasteners, such as screws, rivets or snap-fit couplings.

The handle 120 may be a knob, sphere, hand grip or other structure that is attached to the end of the tether 115 opposite the anchor. The handle 120 helps impede a user's hand gripped to the tether 115 from sliding off the end of the tether 115.

The tether 115 is elastic and several inches in length. In a nonlimiting example, the tether 115 may be a shock cord. The invention is not limited to a particular length or diameter shock cord. In a nonlimiting example, the tether 115 may be from 6 inches to 36 inches in length, with lengths of about 12 to 24 inches being preferred, and a length of about 20 inches being particularly preferred. The diameter of the shock cord may, by way of example and not limitation, be about 1/16″ to ⅜″.

As shown in FIGS. 2 through 4, the ball 105 includes a second aperture 112, opposite the primary aperture 110 through which the tether 115 extends. The second aperture 112 has a dimension (width or diameter) that is larger than the dimension (width or diameter) of the primary aperture 110, and larger than the dimension (width or diameter) of the tether 115, and, if a washer is used, larger than the dimension (width or diameter) of the washer 125. The second aperture allows the anchor to be set outside the ball 105, and then drawn into the cavity of the ball 105. Illustratively, an end of the tether may be drawn through the primary aperture 110, through the cavity 108 of the ball 105, and out of the second aperture 112. Then a washer 125 may be threaded onto the tether 115. Then a knot 114 may be formed, with the washer being between the knot 114 and the primary aperture 110. If the ball is equipped with a notch 106 for containing the washer 125, the washer 125 may be urged into the notch 106 from the secondary aperture 112. If the ball is not equipped with a notch 106 for containing the washer 125, the washer 125 and knot may be drawn into the cavity 108 of the ball 105, by pulling on the portion of the tether 115 extending out of the ball 105 through the primary aperture 110. Thus, the second aperture facilitates formation and location of the anchor.

The ball 105 may be manufactured using any method known in the art for toy ball production, including, without limitation, molding, such as injection molding. Nonlimiting examples of materials from which the ball 105 may be manufactured include resilient elastomeric materials, such as but not limited to, natural rubber, ethylene propylene diene terpolymer, natural polyisoprene: cis-1,4-polyisoprene natural rubber (NR) and trans-1,4-polyisoprene gutta-percha, synthetic polyisoprene, polybutadiene, chloroprene rubber, polychloroprene, butyl rubber, halogenated butyl rubbers, styrene-butadiene rubber, nitrile rubber, hydrogenated nitrile rubbers, ethylene propylene rubber, epichlorohydrin rubber, polyacrylic rubber, Silicone rubber, fluorosilicone rubber, fluoroelastomers, perfluoroelastomers, polyether block amides, chlorosulfonated polyethylene, ethylene-vinyl acetate, polyethylene, polypropylene, polyurethane, polystyrene, polyvinyl chloride, polyvinylidene chloride, polyvinyl vinyl acetate, and polyvinyl alcohol. Any material suitable for a toy ball for dogs may be used.

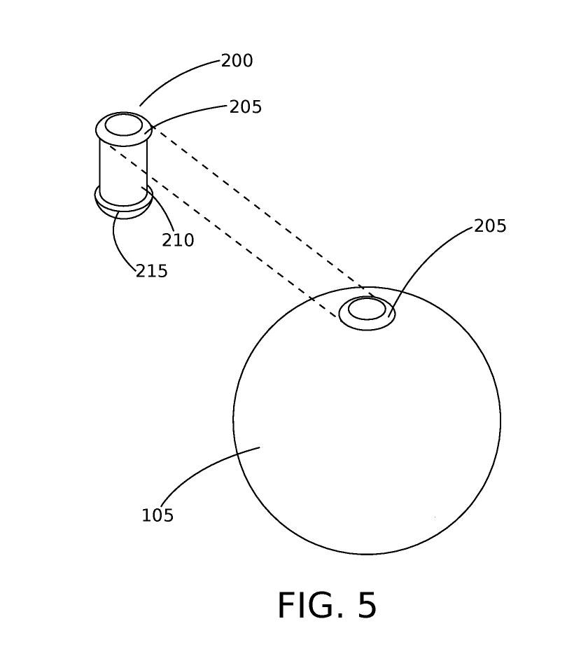

FIG. 5 provides a perspective view of an exemplary ball 105 with a plug 200. The second aperture may be left open or plugged. The exemplary plug 200 is a barbell shaped object, with a shank 210 extending between an outer cap 205 and an inner cap 215. Elasticity and resiliency of the plug 200 and/or ball 105 allows the plug 200 to be urged into the second aperture 112, with the inner cap 215 extending into the inner cavity 108, and the outer cap 205 being substantially flush against the outer surface of the ball 105. The plug 200 may be bonded in place, to prevent inadvertent removal.

In another embodiment, the ball is a tennis ball, i.e., a felt-covered rubber compound ball. Tennis balls are ubiquitous and cost effective.

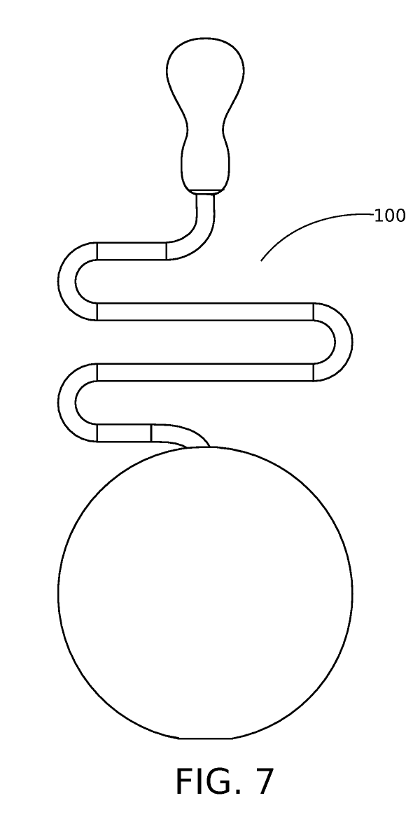

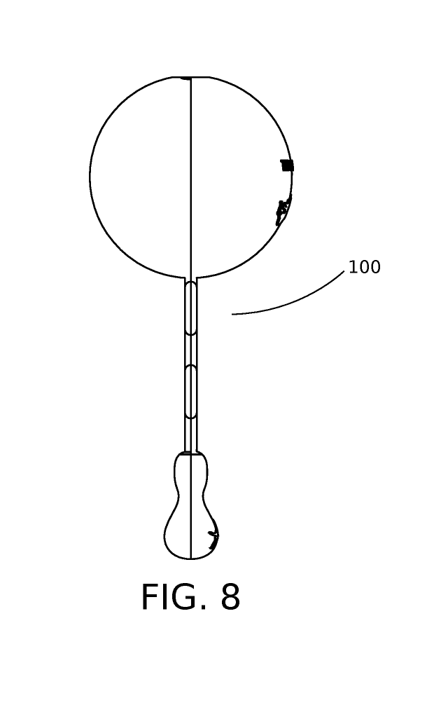

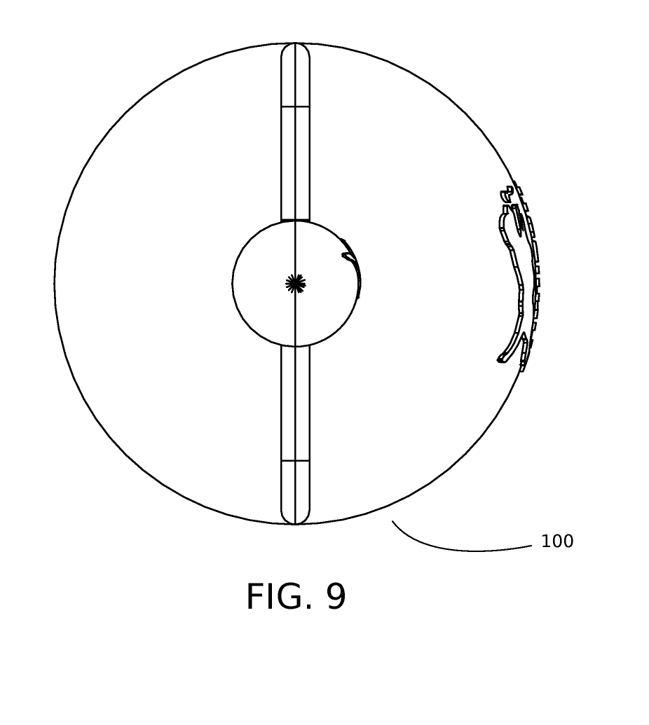

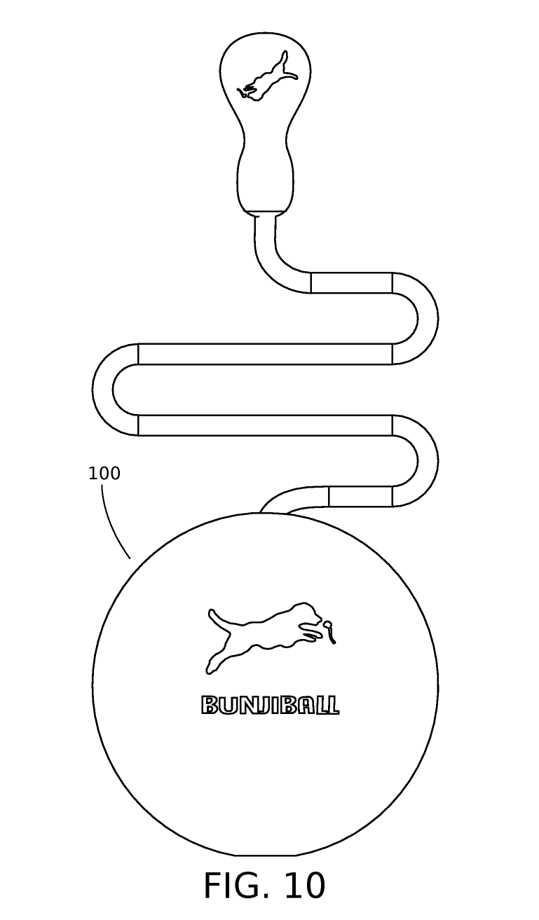

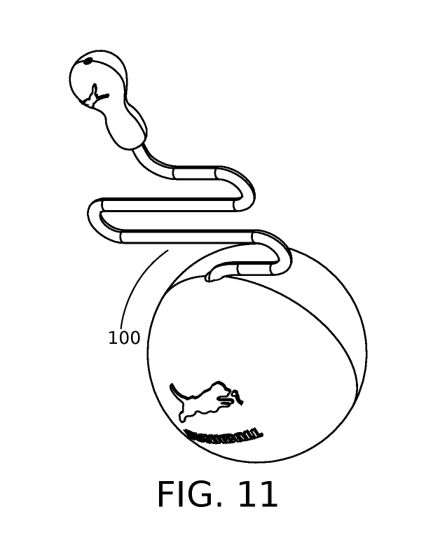

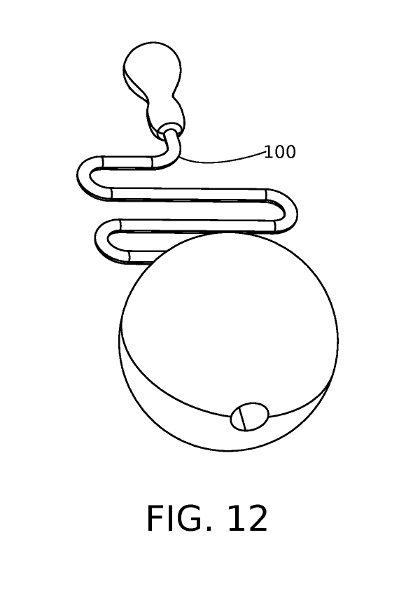

FIGS. 7 through 12 provide various views of an exemplary toy 100 according to principles of the invention. The exemplary toy 100 is a nonlimiting example of one embodiment. The invention is not limited to the handle shape, proportions of components, or ornamental features shown in FIGS. 7 through 12. The various views are provided to illustrate a particular embodiment.

In one exemplary, nonlimiting example, of a mode of use, a person grabs the handle 120 or elastic tether 115 near the handle 120. The person pivots their arm such that their gripping hand travels along a generally arcuate (arc shaped) path, from a starting point to a release point. A person's arm may complete less than one rotation, one rotation or more than one rotation. Centripetal force causes the elastic tether 115 to stretch as the hand travels. At the release point, the grip is released, allowing the ball 105, tether 115 and handle 120 to continue traveling. The stretch of the elastic tether 115 increases the radius of the arcuate path, and, for a constant angular velocity, proportionally increases the tangential velocity of the ball 105. To the delight of a fetching dog, the increase in tangential velocity facilitates long distance travel of the released ball 105, tether 115 and handle 120.

The invention is not limited to ball-shaped toys. Other shapes, such as but not limited to bone, animal, stick, or dumbbell shapes that are suitable for fetching, may be used without departing from the scope of the invention.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A ball toy comprising:
a ball having an internal cavity and a first aperture, the first aperture having a first diameter; and
a tether having a first end and a second end, the second end being opposite the first end, a first portion of the tether extending through the first aperture into the internal cavity of the ball, the first end of the tether being in the internal cavity of the ball, the second end of the tether being outside of the ball, the tether being elastic; and
an anchor at the first end of the tether, the anchor having a width that is greater than the first diameter of the first aperture.

2. The ball toy according to claim 1, further comprising a handle attached to the second end of the tether.

3. The ball toy according to claim 2, the anchor comprising a knot.

4. The ball toy according to claim 3, the anchor further comprising a washer, the washer being a flat ring with an outer diameter greater than the first diameter of the first aperture, and a second portion of the tether extending through the washer, the washer being threaded onto the tether between the knot and the first aperture.

5. The ball toy according to claim 4, further comprising a notch in the ball between the first aperture and the interior compartment, and the washer being disposed in the notch.

6. The ball toy according to claim 2, the anchor comprising a malleable ferrule crimped to the first end of the tether.

7. The ball toy according to claim 2, the anchor comprising a malleable band crimped to the first end of the tether.

8. The ball toy according to claim 2, the ball comprising a resilient elastomeric material.

9. The ball toy according to claim 2, the ball comprising a tennis ball.

10. The ball toy according to claim 1, the ball further comprising a second aperture, the second aperture being opposite the first aperture, and the second aperture having a second aperture diameter that is greater than the width of the anchor.

11. The ball toy according to claim 10, further comprising a plug securely inserted into the second aperture.

12. A fetch toy comprising:
an elastomeric object having an internal cavity and a first aperture, the first aperture having a first diameter; and
a tether having a first end and a second end, the second end being opposite the first end, a first portion of the tether extending through the first aperture into the internal cavity of the elastomeric object, the first end of the tether being in the internal cavity of the elastomeric object, the second end of the tether being outside of the elastomeric object, the tether being elastic; and
an anchor at the first end of the tether, the anchor having a width that is greater than the first diameter of the first aperture.

13. The fetch toy according to claim 12, further comprising a handle attached to the second end of the tether.

14. The fetch toy according to claim 13, the anchor comprising a knot.

15. The fetch toy according to claim 14, the anchor further comprising a washer, the washer being a flat ring with an outer diameter greater than the first diameter of the first aperture, and a second portion of the tether extending through the washer, the washer being threaded onto the tether between the knot and the first aperture.

16. The fetch toy according to claim 15, further comprising a notch in the elastomeric object between the first aperture and the interior compartment, and the washer being disposed in the notch.

17. The fetch toy according to claim 13, the anchor comprising a malleable ferrule crimped to the first end of the tether.

18. The fetch toy according to claim 14, the anchor comprising a malleable band crimped to the first end of the tether.

19. The fetch toy according to claim 12, the elastomeric object further comprising a second aperture, the second aperture being opposite the first aperture, and the second aperture having a second aperture diameter that is greater than the width of the anchor.

20. The fetch toy according to claim 19, further comprising a plug securely inserted into the second aperture.
